(19) United States
(12) Patent Application Publication
(10) Pub. No.: US 2005/0078216 A1
(43) Pub. Date: Apr. 14, 2005

(54) Method of improving audio performance and power utilization of a portable audio device with electronic anti-shock system (EASS)

(76) Inventors: Yuh-Chin Chang, Hsinchu (TW); Hui-Ya Chou, Hsinchu (TW); Hong-Tsan Lee, Hsinchu (TW); Peng-Cheng Chen, Hsinchu (TW)

Correspondence Address: VENABLE, BAETJER, HOWARD AND CIVILETTI, LLP, P.O. BOX 34385, WASHINGTON, DC, 20043-9998, US

(21) Appl. No.: 10/758,532

(22) Filed: Jan. 16, 2004

(30) Foreign Application Priority Data
Oct. 14, 2003 (TW) 092128355

(51) Int. Cl. H04N 7/173; H04N 7/00; H04N 11/00

(52) U.S. Cl. 348/462; 725/100

(57) ABSTRACT

A method of improving performance and power utilization of portable a CD player with an electronic anti-shock system (EASS) is disclosed. When PCM signals are received by the EASS, the audio signals are compressed with a high compression rate algorithm and saved in a temporary memory, and later when the audio data are read out from the temporary memory, the audio data are decoded with the same audio compression algorithm to restore to the original PCM format, thus a data buffering is created between the reading of data and the playback of sound. A high compression rate algorithm can increase the utilization of DRAM memory and lengthen the buffering time considerably. The present invention has incorporated an audio compression algorithm having high compression rate in the EASS to attain the most desirable balance point between audio performance, power management, and costs.

### BACKGROUND OF THE INVENTION

1. Field of the Invention

The present invention is related to a method of improving performance and power utilization of a portable audio device fitted with an electronic anti-shock system (EASS), and more particularly to a method of improving performance and power utilization of a portable audio device such as CD player by employing MPEG, a high compression rate algorithm, to encode/decode audio signals so as to increase the capacity of audio data stored in a temporary memory, as a result extending the buffering time, and realizing power saving.

2. Description of Related Art

CD players usually have an electronic anti-shock system (EASS) or equivalent buffering device that creates a data buffer in the signal processing path between the data retrieval lens and the audio signal processor to prevent interruptions in audio playback. If CD players are subjected to shocks or vibrations during reading of audio data, audio signal processing will be interrupted, and the quality of audio output will be degraded accordingly.

A conventional EASS has the function of a CODEC, a coding-decoding device that converts audio signals into digital bit streams and back again, and the basic structure is shown in FIG. 3, in which separate data paths are used to process audio data going through the right and left audio channels. The input pulse code modulation (PCM) signals going through the right and left channels are respectively processed by a pair of ADPCM encoders (71) (71′), and then saved in a pair of memory devices (DRAM) (72) (72′). For faithful reproduction of the sound, audio compressed data is read from the above memory devices (DRAM) (72) (72′), and then passed to a pair of corresponding ADPCM decoders (73) (73′) to restore to the original PCM signals for the right and left channels. Thereafter, the decoded audio signals in the right and left channels are simultaneously passed to an audio signal processor (74) for output through a speaker. Basing on the above structure, the above mentioned temporary memory in the audio processing path has a buffering effect that can somewhat prevent vibration-caused interruptions during audio playback.

However, the conventional electronic anti-shock system (EASS) employs the adaptive differential pulse code modulation (ADPCM) for encoding and decoding, by which the waveform of the analog signals are sampled at a fixed frequency.

Generally, audio data have to be compressed before they can be saved in a memory. The relationship between data size and the compression rate will be explained hereunder, as it concerns the utilization of memory resources. For example, the waveform of 12 bit/sample is compressed with a 3:1 ratio to become 4 bit/sample, and when reading out data from memory, the data is decompressed with 1:3 ratio to restore to the original audio format of 12 bit/sample for sound reproduction. Therefore, the memory used to save the audio data is less than that with standard PCM codes, but the compression rate is not adequate for saving large amounts of audio data in the limited memory of a CD player.

The compression coding scheme for the above-mentioned conventional ADPCM encoder (71) can be implemented in either 3-bit mode or 4-bit mode. Since all current audio equipment has at least two audio channels, the 4-bit operation mode is selected in this example for calculation of the bit rate with a sampling frequency of 44.1 KHz:
4(bits)×44100×2(number of audio channels)=352,800 Kbps

If the operation is in 3-bit operation mode, the bit rate is:
3(bits)×44100×2(number of audio channels)=264,600 Kbps

If the memory installed in the above anti-shock system is 16M bits, as in the present example, the required buffering time for the two operation modes can be:
4-bit mode:16,000,000÷352,800=45.35 (sec)
3-bit mode:16,000,000÷264,600=60.46 (sec)

From the above explanation, the buffering time of the EASS is dependent on the bit rate and the memory capacity. The data saving operation in the EASS has to be sustained for a longer duration if the performance of a CD player having EASS is to show any noticeable improvement.

Within the constraint not to increase a DRAM memory, the only way to improve the performance of CD player is to increase the bit rate in the audio compression. If the compression rate is increased, the performance of EASS can be improved without using additional memory.

However, the ADPCM algorithm primarily is not primarily designed for audio data compression, as the above compression rate cannot support high capacity storage in limited memory storage of a portable CD player. Satisfactory buffering will need large amount of DRAM memory, which is quite difficult for a compact sized CD player, not to mention the increased costs.

From the foregoing, it is quite clear that ADPCM cannot satisfy the present requirement of data conversion with high compression, but there are some more advanced compression algorithms, such as the MPEG layer I and II, which are able to produce reasonably acceptable sound quality with much better utilization of memory than ADPCM. Audio data with double or triple larger size can be saved in the same amount of memory space as compared with the conventional ADPCM-based systems.

For portable CD players, another benefit of using MPEG in the EASS is the power saving feature. When the audio data is read from the data buffer, the servomotor of the CD player is kept in a suspended mode. Therefore, the longer the CD servo can be suspended by the operation in the data buffer, the less the system power is used.

Therefore, the present invention attempts to incorporate an audio compression algorithm having high compression rate in the EASS to attain the most desirable balance point between audio performance, power management, and costs.

### SUMMARY OF THE INVENTION

The main object of the present invention is to provide a method for improving the audio performance of a portable CD player by adopting the Moving Picture Experts Group (MPEG), a high compression rate algorithm, in the electronic anti-shock system (EASS), so as to increase the storage capacity of the temporary memory and extend the buffering time.

When PCM signals are received, the EASS use an MPEG compression algorithm with high compression rate to convert the PCM signals to digital values in the form of data streams and save them in the temporary memory. Conversely, when the audio compressed data are read out from the temporary memory, EASS uses the above compression algorithm to convert the audio compressed data to restore to the original PCM format for sound reproduction.

The precondition for using the MPEG compression algorithm is that the sound reproduction of the CD player shall closely resemble the sound quality in the information medium (CD). Since the compression rate using MPEG is a multiple of the conventional ADPCM, a double or triple amount of audio data can be saved in the temporary memory, thus the buffering time of the EASS can be lengthened considerably. Therefore, the system can effectively prevent vibration-caused interruptions during audio playback.

The above audio compression format can be either MPEG 1 or MPEG 2.

The secondary object of the present invention is to provide an improved electronic anti-shock system (EASS) for portable CD players that is capable of realizing power saving. During the data operation in the buffer memory, the CD servomotor can be kept in the suspended mode using minimal power, as compared with the active mode, in which the servomotor becomes a major power user in the system.

Other objectives, advantages and novel features of the invention will become more apparent from the following detailed description when taken in conjunction with the accompanying drawings.

### BRIEF DESCRIPTION OF THE DRAWINGS

FIG. 1 is a comparative chart of the compression rates between MPEG layer II and layer III showing data sizes in different stages;

FIG. 2 is a system block diagram of the present invention; and

FIG. 3 is a system block diagram of a conventional electronic anti-shock system (EASS).

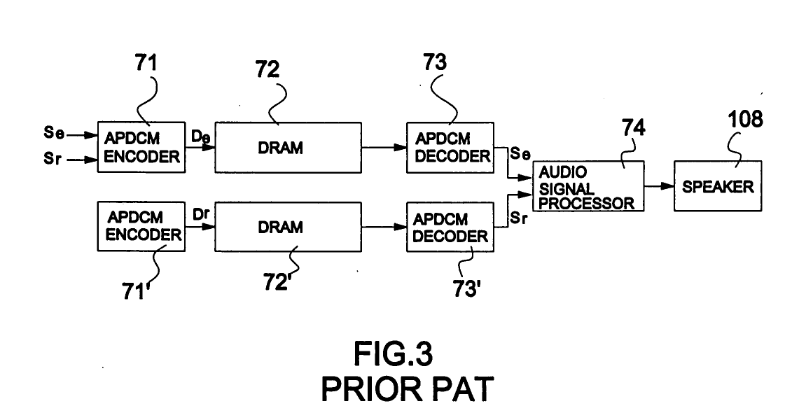

### DETAILED DESCRIPTION OF THE PREFERRED EMBODIMENT

The disclosed electronic anti-shock system (EASS) is created by converting the input PCM signals to bit streams and saving them in a temporary memory to create a data buffer and after a predetermined amount of time the audio data are read out from memory and converted back to the original PCM format for sound reproduction.

According to the present invention, a high audio compression algorithm such as MPEG is used to convert the input PCM signals to audio compressed data and save them in temporary memory, and after a certain time the saved audio data are read out from the temporary memory and converted by the same audio compression algorithm back to the original PCM format;

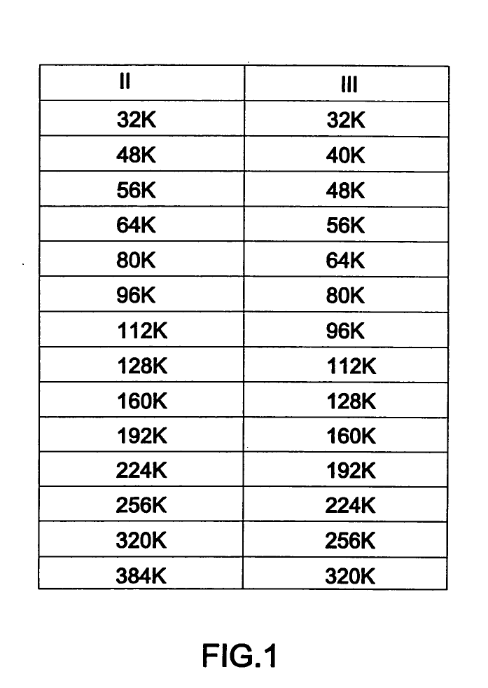

Since the compression rate tends to be inversely related to the quality of sound reproduction, the adoption of a high compression rate has to be very carefully considered to not affect the reproduction quality during playback. The advanced compression algorithm, such as the Moving Picture Experts Group(MPEG)/layer II and III, is able to produce acceptable sound quality using much less memory than in an ADPCM, provided that the sound reproduction of the CD player shall closely resemble the sound quality in the recording medium (CD). The compression rates of MPEG Layer II, Layer III are shown in FIG. 1. It is clear that the MPEG Layer III is even more powerful occupying even smaller memory.

For a CD player having EASS, the application of Layer II and Layer III will produce different results, because the buffering time for implementation with Layer III will be longer than that with Layer II given the same amount of memory.

For example, as shown in FIG. 1, using 160K bits compression rate with LAYER II, and 128K bits with LAYER III; and applying this on a DRAM memory with a capacity of 16M bits, the buffering time can thus be computed as follows:
LAYER II: 16,000,000(bits)÷160,000(bps)≈100 (sec)
LAYER III: 16,000,000(bits)÷128,000(bps)≈125 (sec)

Compared with the ADPCM algorithm in the 3-bit and 4 bit modes, the buffering time will be extended two to three times longer, thus the efficiency of the EASS can be improved considerably preventing vibration-caused interruptions in audio playback.

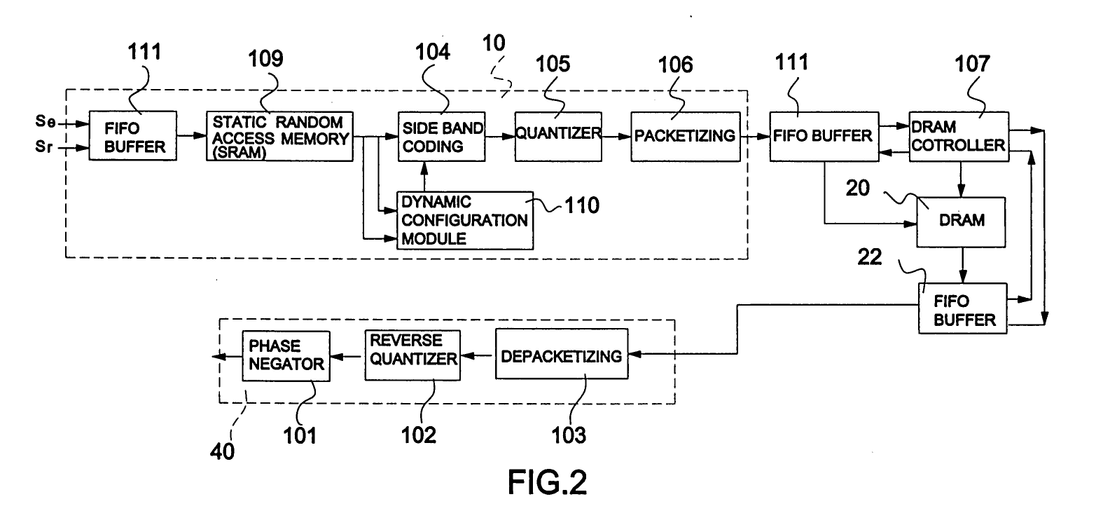

The structure of the present invention, as implemented in one preferred embodiment is shown in FIG. 2, comprises a MPEG encoder (10), a memory device (DRAM) (20), a DRAM controller (30), and an MPEG decoder (40).

The MPEG encoder (10) is used for converting PCM signals in the left channel (sₗ) and the right channel(sᵣ) and applying the MPEG compression algorithm to produce audio compressed data streams.

The memory device (DRAM) (20) is used for temporarily keeping audio data en route to the audio signal processor, of which the input and the output are respectively connected by a FIFO buffer (21) (22), and the input FIFO buffer (21) is connected to the output of the MPEG encoder (10).

The DRAM controller (30) is used for regulating the data flow to or from the memory device (DRAM) (20), wherein the DRAM controller (30) is respectively connected with the memory device (DRAM) (20) and two FIFO buffers (21) (22).

The MPEG decoder (40) is used for decoding the audio compressed data passed from the memory device (20), and restoring them to the original PCM format for sound reproduction, wherein the MPEG decoder (40) is connected to the memory device (DRAM) (20) through the FIFO buffer (22).

The above MPEG encoder (10) and MPEG decoder (40) may be in compliance with either MPEG 1 or MPEG 2 specifications.

The data processing operation under the above mentioned architecture is to be explained with reference to FIG. 2.

Input PCM signals of the left and right channel (sₗ) (sᵣ) are passed to the MPEG encoder (10) to produce audio compressed data, wherein the data are temporarily saved in a static random access memory (SRAM) through a FIFO buffer (unnumbered), which enables a dynamic configuration module to conduct sideband coding, and then the audio data are further processed through quantizing and packetizing to produce a digital data stream representing the audio compressed data.

The data stream through the FIFO buffer (21) is written into the memory device (DRAM) (20) by means of the DRAM controller (30). Since the MPEG encoder (10) uses a high compression rate in the signal processing, the amount of output data from the MPEG encoder (10) is considerably reduced, and the utilization of the memory device (DRAM) (20) can thus be improved.

Thereafter, the audio data, saved in the memory device (20) for a predetermined time, are read out and passed to the MPEG decoder (40) through the FIFO buffer (22), wherein the data are first depacketized to remove the encapsulation over the data, and then further through reverse quantizing and phase negation to restore to the original PCM format. After further reconfiguration and signal processing, the audio signals are played back over the speaker.

From the foregoing, it is apparent that the instrumentality of the present invention is to increase the compression rate of the EASS so as to increase the utilization of temporary memory. As a result, the system can prevent vibration or shock-caused interruptions during audio playback. However, the precondition to using the high compression rate algorithm is that the quality of sound reproduction of the CD player has to closely resemble the original recording level on the information medium (CD). If the above condition can be satisfied, the buffering time can be effectively lengthened, and the power saving can also be realized by increasing the time of the CD servomotor in the suspended mode.

When compared with the ADPCM compression algorithm, double or triple amounts of audio data can be saved in the same amount of memory, and the buffering time of the EASS can be lengthened considerably.

According to the present invention, the CD player having EASS is able to achieve the most desirable balance point between audio performance, power saving and low cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of improving an electronic anti-shock system (EASS), in which when PCM signals are received by the EASS, the system first processes the audio signals with high compression algorithm motion picture expert group (MPEG) to convert to audio compressed data and then save the audio data in a temporary memory, and after a certain time the system reads out the audio compressed data from the temporary memory through a decoding process with the same audio compression algorithm and restores the audio data to the original PCM format, such that a data buffer is created during signal processing for a suitable buffering time, while the quality of sound reproduction can be assured.

2. The method of improving EASS as claimed in claim 1, wherein the audio compression algorithm is MPEG 1.

3. The method of improving EASS as claimed in claim 1, wherein the audio compression algorithm is MPEG 2.

4. An electronic anti-shock system (EASS) comprising:
an MPEG encoder, which converts input PCM signals in the left and right channels to audio compressed data streams complying with the MPEG specifications;
a memory device (DRAM), of which the input and the output are respectively connected by a first and a second FIFO buffer, and the input of the first FIFO buffer is connected to the output of the MPEG encoder;
a DRAM controller, which is respectively connected with the memory device (DRAM) and two FIFO buffers to regulate the data flow to /from the Memory device (DRAM); and
an MPEG decoder connected to memory device (DRAM) through the FIFO buffer, which converts audio compressed data back to the original PCM format for sound reproduction.

5. The EASS as claimed in claim 4, wherein the MPEG encoder and the MPEG decoder adopt the MPEG 1 format.

6. The EASS as claimed in claim 4, wherein the MPEG encoder and MPEG decoder adopt the MPEG 2 format.
